(19) United States
(12) Patent Application Publication
(10) Pub. No.: US 2021/0263490 A1
(43) Pub. Date: Aug. 26, 2021

(54) WATER TREATMENT PLANT AND METHOD OF OPERATING WATER TREATMENT PLANT

(71) Applicant: Mitsubishi Electric Corporation, Tokyo (JP)

(72) Inventors: Yohei UENO, Tokyo (JP); Eiji IMAMURA, Tokyo (JP); Takumi SUDA, Tokyo (JP); Nozomu YASUNAGA, Tokyo (JP); Takushi KAWADA, Tokyo (JP); Go WAKAMATSU, Tokyo (JP); Kenta SHIMODA, Tokyo (JP)

(73) Assignee: Mitsubishi Electric Corporation, Tokyo (JP)

(21) Appl. No.: 17/261,570

(22) PCT Filed: Jul. 26, 2018
(86) PCT No.: PCT/JP2018/028152

§ 371 Date: Jan. 20, 2021

(51) Int. Cl. G05B 19/042

(52) U.S. Cl. CPC G05B 19/042; G05B 2219/2605

(57) ABSTRACT

A water treatment plant that performs water treatment using a water treatment facility includes: a sensor that repeatedly detects a water treatment environment of the water treatment facility to output time-series detection data; and a processor. The processor causes an arithmetic circuitry to execute a computation related to control of the water treatment facility using the time-series detection data as input data for a calculation model generated by machine learning.

### FIELD

The present invention relates to a water treatment plant for performing water purification, sewage treatment, or the like, and to a method of operating a water treatment plant.

### BACKGROUND

In a water treatment plant, water treatment control is performed by changing control target values according to environmental changes. For example, water treatment control that adapts to environmental changes is performed in the water treatment plant by changing control target values according to seasonal temperature differences and changes in the flow rate of inflow water, the water quality of inflow water, and the like.

Control target values are changed by operators based on past experiences and the like, which require expertise. Patent Literature 1 proposes a technique of using artificial intelligent (AI) for controlling a sewage treatment apparatus so that the experience of operators can be reflected in changing control target values according to environmental changes. This technique includes inputting, to an AI device, detection data output from a sensor that detects the internal state of the sewage treatment apparatus, the detection data indicating current values of the internal state of the sewage treatment apparatus, and controlling the sewage treatment apparatus based on the output of the AI device.

### CITATION LIST

### Patent Literature

Patent Literature 1: Japanese Patent Application Laid-open No. 2004-25160

### SUMMARY

### Technical Problem

The above-described conventional AI-based water treatment control considers the future internal state of the water treatment facility from the current internal state thereof. However, there is room for improvement in the above-described conventional AI-based water treatment control. For example, the water treatment environment, such as the state or environment of the water treatment facility, undergoes moment-to-moment changes that are temporally linked, but such temporal linkages are not sufficiently considered.

The present invention has been made in view of the above, and an object thereof is to obtain a water treatment plant capable of performing more effective water treatment control against environmental changes.

### Solution to Problem

A water treatment plant according to the present invention performs water treatment using a water treatment facility, the water treatment plant includes: a sensor to repeatedly detect a water treatment environment of the water treatment facility to output time-series detection data; and a processor to cause an arithmetic circuitry, which executes a computation related to control of the water treatment facility using a calculation model generated by machine learning, to execute the computation using the time-series detection data output from the sensor as input data.

### Advantageous Effects of Invention

The present invention can achieve the effect of providing a water treatment plant capable of performing more effective water treatment control against environmental changes.

### BRIEF DESCRIPTION OF DRAWINGS

FIG. 1 is a diagram schematically illustrating a water treatment plant according to a first embodiment.

FIG. 2 is a diagram illustrating an exemplary configuration of the water treatment plant according to the first embodiment.

FIG. 3 is a diagram illustrating an exemplary configuration of a processor according to the first embodiment.

FIG. 4 is a diagram illustrating an example of a data table stored in a storage according to the first embodiment.

FIG. 5 is a diagram illustrating an exemplary configuration of an arithmetic circuitry according to the first embodiment.

FIG. 6 is a diagram illustrating an exemplary configuration of a controller according to the first embodiment.

FIG. 7 is a flowchart illustrating an exemplary procedure that is performed by the processor according to the first embodiment.

FIG. 8 is a flowchart illustrating an exemplary procedure that is performed by the arithmetic circuitry according to the first embodiment.

FIG. 9 is a flowchart illustrating an exemplary procedure that is performed by the controller according to the first embodiment.

FIG. 10 is a diagram illustrating an exemplary hardware configuration of the processor according to the first embodiment.

### DESCRIPTION OF EMBODIMENTS

Hereinafter, a water treatment plant and a method of operating a water treatment plant according to an embodiment of the present invention will be described in detail with reference to the drawings. The present invention is not limited to the embodiment.

### First Embodiment

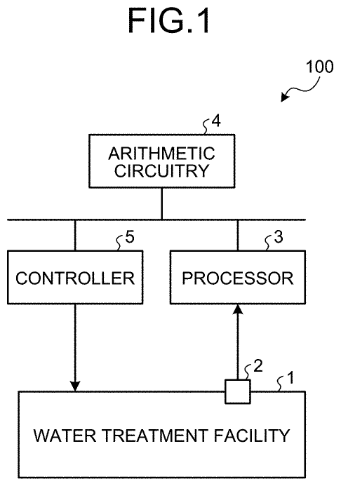

FIG. 1 is a diagram schematically illustrating a water treatment plant according to the first embodiment. As illustrated in FIG. 1, the water treatment plant 100 according to the first embodiment includes a water treatment facility 1, a sensor 2, a processor 3, an arithmetic circuitry 4, and a controller 5. The arithmetic circuitry 4 is an example of an AI device.

The water treatment facility 1 is, for example, a facility that performs water purification, sewage treatment, or the like, and includes a control target device such as a pump or a blower that controls the state of water treatment. The controller 5 controls the water treatment facility 1. The sensor 2 repeatedly detects the water treatment environment of the water treatment facility 1 to output time-series detection data. The water treatment environment of the water treatment facility 1 includes at least one of a water treatment environment inside the water treatment facility 1 and a water treatment environment outside the water treatment facility 1. Hereinafter, the water treatment environment of the water treatment facility 1 may be simply referred to as the water treatment environment.

The processor 3 causes the arithmetic circuitry 4 to execute computation that uses acquired time-series detection data as input data, and acquires the result of computation from the arithmetic circuitry 4. The arithmetic circuitry 4 has a calculation model used for computation related to the control of the water treatment facility 1, and the calculation model is generated by machine learning.

The calculation model used for computation by the arithmetic circuitry 4 is a calculation model that outputs information related to the control of the water treatment facility 1 from time-dependent changes in the water treatment environment of the water treatment facility 1, and is generated by machine learning based on time-dependent changes in the water treatment environment of the water treatment facility 1.

Such a calculation model is, for example, a calculation model that receives input of time-series detection data output from the sensor 2 and outputs information on a control target value for a control target device. The control target value is, for example, a target value of the amount of control on a control target device such as a pump, a blower, or a heater that controls the state of water treatment in the water treatment facility 1.

The arithmetic circuitry 4 performs computation with the above-mentioned calculation model that uses the time-series detection data acquired from the processor 3 as input data. The arithmetic circuitry 4 outputs, to the processor 3, information including the result of computation with the calculation model. The processor 3 outputs, to the controller 5, the information acquired from the arithmetic circuitry 4. The controller 5 controls the water treatment facility 1 based on the information output from the processor 3. The arithmetic circuitry 4 is, for example, artificial intelligence (AI), and contributes to the estimation of a preferable control target value for a control target device through machine learning that is based on input time-series detection data.

In the water treatment plant 100, the calculation model used for computation by the arithmetic circuitry 4 can be a calculation model that receives input of time-series detection data output from the sensor 2 and outputs a predicted value of the water treatment environment.

In this case, the processor 3 can display, on a display (not illustrated), the predicted value of the water treatment environment acquired from the arithmetic circuitry 4. Consequently, the operator of the water treatment plant 100 can control the water treatment facility 1 via the processor 3 based on past experience or the like while grasping the predicted value of the water treatment environment displayed on the display (not illustrated). Hereinafter, the operator of the water treatment plant 100 may be simply referred to as the operator.

As described above, in the water treatment plant 100, computation is performed with the calculation model generated by machine learning based on time-dependent changes in the water treatment environment. Consequently, in the water treatment plant 100 according to the first embodiment, effective water treatment control can be performed in consideration of time-dependent changes in the water treatment environment.

For example, in a case where only current values of the water treatment environment are used, it may be difficult to properly grasp how the water treatment environment changes because it is not known how the water treatment environment has changed up to the present. On the other hand, the water treatment plant 100 can appropriately grasp how the water treatment environment changes by considering time-dependent changes in the water treatment environment, and can accurately predict future changes in the water treatment environment. Therefore, the water treatment plant 100 can perform water treatment control in consideration of future changes in the water treatment environment, and can perform effective water treatment control against changes in the water treatment environment.

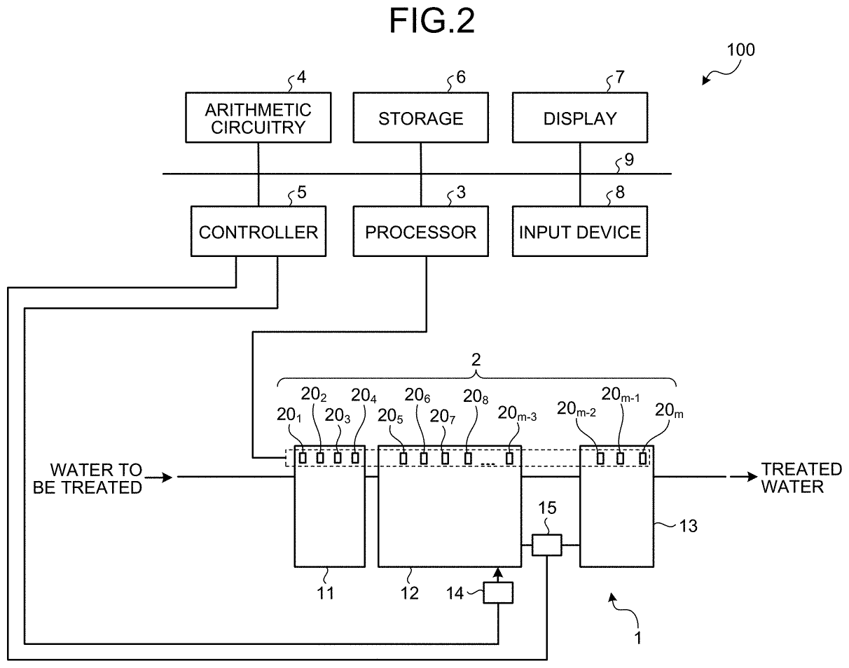

Hereinafter, the water treatment plant 100 according to the first embodiment will be described in detail. FIG. 2 is a diagram illustrating an exemplary configuration of the water treatment plant according to the first embodiment. Note that the following description refers to sewage treatment as an example of water treatment performed by the water treatment facility 1.

As illustrated in FIG. 2, the water treatment plant 100 according to the first embodiment includes the water treatment facility 1, the sensor 2, the processor 3, the arithmetic circuitry 4, the controller 5, a storage 6, a display 7, and an input device 8.

The processor 3, the arithmetic circuitry 4, the controller 5, the storage 6, the display 7, and the input device 8 are communicatively connected to each other via a communication network 9. The communication network 9 is, for example, a local area network (LAN), a wide area network (WAN), a bus, or a dedicated line.

The water treatment facility 1 illustrated in FIG. 2 is a sewage treatment apparatus that treats sewage as water to be treated. The water treatment facility 1 includes a primary settling tank 11, a treatment tank 12, and a final settling tank 13. The primary settling tank 11 stores sewage, which is inflow water from sewers or the like, and precipitates solid matter that is relatively well settled in the sewage. The treatment tank 12 aerobically treats the supernatant water of the primary settling tank 11. The final settling tank 13 separates the activated sludge mixture flowing in from the treatment tank 12 into supernatant water and activated sludge. The supernatant water of the final settling tank 13 is discharged from the final settling tank 13 as treated water.

In the treatment tank 12, the supernatant water flowing in from the primary settling tank 11 contains organic matter. The organic matter contained in the supernatant water is treated, for example, by digestion of aerobic microorganisms such as phosphorus-accumulating bacteria, nitrifying bacteria, and denitrifying bacteria.

The water treatment facility 1 further includes a blower 14 and a pump 15. The blower 14 sends air into the treatment tank 12 to dissolve the air in the activated sludge mixture. The pump 15 is provided at a pipe that connects the final settling tank 13 and the treatment tank 12, and returns activated sludge from the final settling tank 13 to the treatment tank 12. Each of the blower 14 and the pump 15 is an example of the control target device described above. Hereinafter, the blower 14 and the pump 15 may be collectively referred to as a control target device. The primary settling tank 11, the treatment tank 12, and the final settling tank 13 may be collectively and simply referred to as the tanks.

The water treatment plant 100 is equipped with the sensor 2 including a plurality of sensors 20₁ to 20ₘ that each detect the water treatment environment of the water treatment facility 1. Each of the sensors 20₁ to 20ₘ detects, for example, the internal state or environment of the water treatment facility 1. Specifically, the water treatment environment of the water treatment facility 1 includes, for example, in-tank conditions such as characteristics of inflow to the tanks, the state of water treatment in the tanks, and characteristics of outflow from the tanks. The internal environment of the water treatment facility 1 includes, for example, the temperature and humidity of the atmosphere in the water treatment facility 1. The following description refers to the internal state of the water treatment facility 1, but the same applies to the internal environment of the water treatment facility 1, the external state or environment of the water treatment facility 1, and the like.

The sensors 20₁ to 20₄ detect inflow water characteristics that are characteristics of inflow water into the primary settling tank 11. The sensor 20₁ detects a characteristic value Da1 that is the inflow amount of inflow water. The sensor 20₂ detects a characteristic value Da2 that is the biochemical oxygen demand (BOD) of inflow water. The sensor 20₃ detects a characteristic value Da3 that is the temperature of inflow water. The sensor 20₄ detects a characteristic value Da4 that is the concentration of NH₃ in inflow water, the concentration of NH₄⁺ in inflow water, or the concentration of ammoniacal nitrogen.

The sensors 20₅ to 20ₘ₋₃ detect in-treatment-tank characteristics indicating the state of the treatment tank 12. The sensor 20₅ detects a characteristic value Da5 that is the amount of dissolved oxygen in the treatment tank 12. The sensor 20₆ detects a characteristic value Da6 that is the concentration of active microorganisms in the treatment tank 12. The sensor 20₇ detects a characteristic value Da1 that is a BOD in the treatment tank 12. The sensors 20₈ to 20ₘ₋₃ include, for example, a plurality of sensors that detect characteristic values Da8 to Dam-3 that are the concentration of ammoniacal nitrogen, the concentration of nitrate nitrogen, the concentration of total nitrogen, the concentration of phosphoric acid phosphorus, or the concentration of total phosphorus.

The sensors 20ₘ₋₂ to 20ₘ detect treated water characteristics that are characteristics of treated water discharged from the final settling tank 13. The sensor 20ₘ₋₂ detects a characteristic value Dam-2 that is the outflow amount of treated water. The sensor 20ₘ₋₁ detects a characteristic value Dam-1 that is the BOD of treated water. The sensor 20ₘ detects a characteristic value Dam that is the concentration of total nitrogen in treated water.

Note that the sensor 2 may not include one or more of the sensors 20₁ to 20ₘ, and may include sensors other than the sensors 20₁ to 20ₘ. The sensors 20₁ to 20ₘ described above detect the characteristic values Da1 to Dam indicating the internal state of the water treatment facility 1, but the sensor 2 may include, for example, an imaging device that outputs imaging data of the water treatment environment as detection data. Hereinafter, the sensors 20₁ to 20ₘ may be collectively referred to as the sensor 20. The characteristic values Da1 to Dam may be collectively referred to as the characteristic value Da.

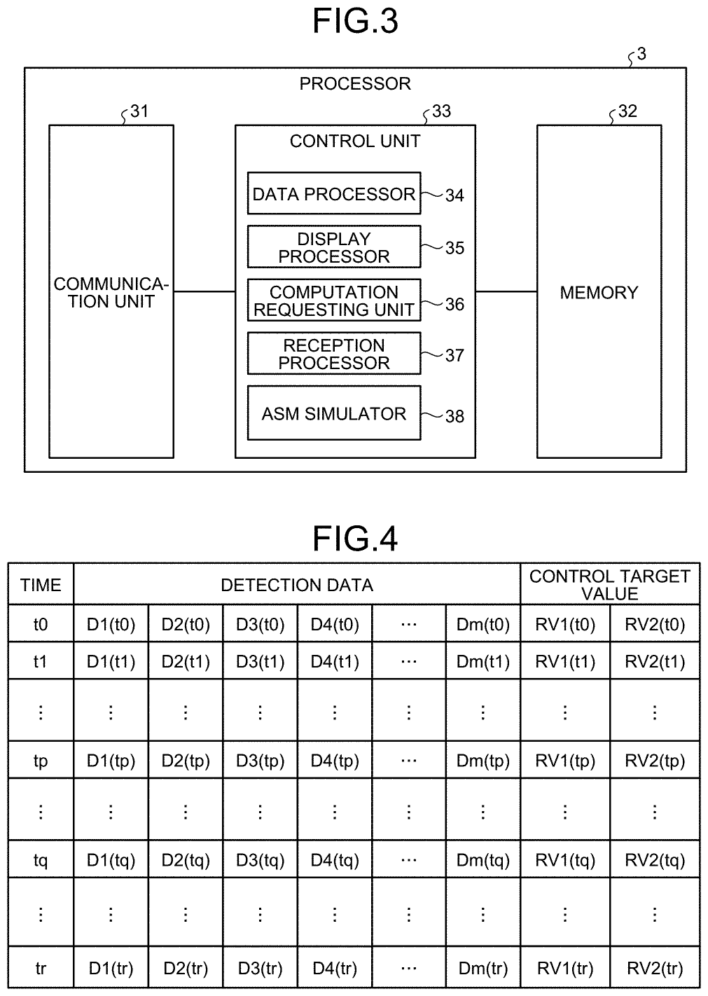

FIG. 3 is a diagram illustrating an exemplary configuration of the processor according to the first embodiment. As illustrated in FIG. 3, the processor 3 includes a communication unit 31, a memory 32, and a control unit 33. The communication unit 31 is connected to the communication network 9. The control unit 33 can exchange data with the arithmetic circuitry 4, the controller 5, the storage 6, the display 7, and the input device 8 via the communication unit 31 and the communication network 9.

The control unit 33 includes a data processor 34, a display processor 35, a computation requesting unit 36, a reception processor 37, and an ASM simulator 38. The data processor 34 repeatedly acquires detection data output from the sensor 2.

The data processor 34 stores, in the storage 6, the detection data acquired from the sensor 2 in association with the time. The data processor 34 also acquires the information output from the arithmetic circuitry 4 and outputs the acquired information to the controller 5. The data processor 34 also stores the information acquired from the arithmetic circuitry 4 in the storage 6.

FIG. 4 is a diagram illustrating an example of a data table stored in the storage according to the first embodiment. The data table illustrated in FIG. 4 includes detection data and control target values for each time. In FIG. 4, detection data D1(t0), D1(t1), . . . , D1(tp), . . . , D1(tq), . . . , and D1(tr) are detection data from the sensor 20₁. Detection data D2(t0), D2(t1), . . . , D2(tp), . . . , D2(tq), . . . , and D2(tr) are detection data from the sensor 20₂.

Detection data D3(t0), D3(t1), . . . , D3(tp), . . . , D3(tq), . . . , and D3(tr) are detection data from the sensor 20₃. Detection data D4(t0), D4(t1), . . . , D4(tp), . . . , D4(tq), . . . , and D4(tr) are detection data from the sensor 20₄. The detection data Dm(t0), Dm(t1), . . . , Dm(tp), . . . , Dm(tq), . . . , and Dm(tr) are detection data from the sensor 20ₘ.

The detection data D1(t0), D2(t0), D3(t0), D4(t0), . . . , and Dm(t0) are data that constitute D(t0) output from the sensor 2 at time t0. The detection data D1(t1), D2(t1), D3(t1), D4(t1), . . . , and Dm(t1) are data that constitute D(t1) output from the sensor 2 at time t1. The detection data D1(tp), D2(tp), D3(tp), D4(tp), . . . , and Dm(tp) are data that constitute D(tp) output from the sensor 2 at time tp.

The detection data D1(tq), D2(tq), D3(tq), D4(tq), . . . , and Dm(tq) are data that constitute D(tq) output from the sensor 2 at time tq. The detection data D1(tr), D2(tr), D3(tr), D4(tr), . . . , and Dm(tr) are data that constitute D(tr) output from the sensor 2 at time tr. Hereinafter, the detection data D(t0), D(t1), . . . , D(tp), . . . , D(tq), . . . , and D(tr) output from the sensor 2 may be collectively referred to as the detection data D.

The data table illustrated in FIG. 4 also includes information on the control target value for each control target device output from the processor 3 to the controller 5 at each time. In FIG. 4, control target values RV1(t0), RV1(t1), . . . , RV1(tp), . . . , RV1(tq), . . . , and RV1(tr) are control target values for the blower 14. Control target values RV2(t0), RV2(t1), . . . , RV2(tp), . . . , RV2(tq), . . . , and RV2(tr) are control target values for the pump 15.

Hereinafter, the control target values RV1(t0), RV1(t1), . . . , RV1(tp), . . . , RV1(tq), . . . , and RV1(tr) may be collectively referred to as the control target value RV1; and the control target values RV2(t0), RV2(t1), . . . , RV2(tp), . . . , RV2(tq), . . . , and RV2(tr) may be collectively referred to as the control target value RV2. The control target values RV1 and RV2 may be collectively referred to as the control target value RV.

The data processor 34 reads out, from the storage 6, time-series detection data Dts1 and time-series control target values RVts1 acquired at times in a period Tb before the present time and at the present time. For example, suppose that the data table of the storage 6 is in the state illustrated in FIG. 4, the present time is time tr, and the past time separated by the period Tb from the present time is time tq. In this case, the data processor 34 reads out, from the storage 6, the time-series detection data Dts1 including the detection data D(tq) to D(tr) and the time-series control target values RVts1 including the control target values RV(tq) to RV(tr). Note that the time-series detection data Dts1 may not include detection data from one or more of the sensor 20 of the plurality of sensors 20₁ to 20ₘ.

The data processor 34 outputs, to the arithmetic circuitry 4 via the communication network 9, the time-series detection data Dts1 and the time-series control target values RVts1 read out from the storage 6. The computation requesting unit 36 outputs the time-series detection data Dts1 and the time-series control target values RVts1 to the arithmetic circuitry 4 to cause the arithmetic circuitry 4 to execute computation that uses the time-series detection data Dts1 and the time-series control target values RVts1 as input data.

In a case where the calculation model used in the arithmetic circuitry 4 is a recurrent neural network, for example, the data processor 34 can cause the arithmetic circuitry 4 to execute computation with the calculation model by repeatedly transmitting newly acquired detection data D and control target values RV after transmitting the time-series detection data Dts1 and the time-series control target values RVts1 to the arithmetic circuitry 4.

The data processor 34 acquires information indicating the result of computation output from the arithmetic circuitry 4, and outputs the acquired information to the controller 5. The information output from the arithmetic circuitry 4 includes, for example, control information including the control target value RV for a control target device; and the controller 5 controls the water treatment facility 1 by controlling the control target device provided in the water treatment facility 1 based on the information output from the processor 3.

Let us now return to FIG. 3 to continue the explanation of the control unit 33. The display processor 35 displays, on the display 7, the detection data D acquired by the data processor 34 and the result of computation by the arithmetic circuitry 4. The display processor 35 can also acquire, from the storage 6, the information input by the operator's operation on the input device 8, and display the acquired information on the display 7. Hereinafter, the operator's operation on the input device 8 may be referred to as the operator's operation.

The reception processor 37 can receive the setting of the control target value RV for the controller 5 based on the operator's operation. The data processor 34 can cause the controller 5 to execute control that is based on the control target value RV received by the reception processor 37 by outputting the control target value RV received by the reception processor 37 to the controller 5.

The reception processor 37 receives, based on the operator's operation, the selection of time-series detection data Dts2 to be used for the learning process for the calculation model held by the arithmetic circuitry 4, from among the multiple pieces of detection data D stored in the storage 6. For example, the reception processor 37 can receive the selection of the time-series detection data Dts2, from among the multiple pieces of detection data D stored in the storage 6, through the designation of a period by the operator's operation.

With the data table of the storage 6 being in the state illustrated in FIG. 4, suppose that the operator designates the period from time tp to time tq. In this case, the reception processor 37 receives the selection of the detection data D(tp) to D(tq) as the time-series detection data Dts2. Note that the detection data Dts2 may not include detection data from one or more of the sensor 20 of the plurality of sensors 20₁ to 20ₘ, like the detection data Dts1.

The computation requesting unit 36 acquires, from the storage 6, the time-series detection data Dts2 selected via the reception processor 37. The computation requesting unit 36 also acquires, from the storage 6, information on time-series control target values RVts2 including a plurality of control target values RV associated with a plurality of acquisition times of the multiple pieces of detection data D included in the time-series detection data Dts2 selected via the reception processor 37. For example, in a case where the detection data D(tp) to D(tq) are selected, the time-series control target values RVts2 include the control target values RV(tp) to RV(tq).

The data processor 34 transmits learning data including the time-series detection data Dts2 and the time-series control target values RVts2 to the arithmetic circuitry 4 via the communication network 9. Consequently, the arithmetic circuitry 4 performs the learning process for the calculation model.

The activated sludge model (ASM) simulator 38 is, for example, a simulator that performs computations with an activated sludge model to simulate physical, biological, and scientific behavior in water treatment. The activated sludge model is a model that mathematically describes biological reaction processes, water quality changes in terms of mass balance, and the like, published by, for example, the International Water Association (IWA). The ASM simulator 38 can predict in-treatment-tank characteristics and treated water characteristics from the characteristic values Da indicating the internal state of the water treatment facility 1, for example, through computation with the activated sludge model.

The reception processor 37 receives a request for a learning process by the ASM simulator 38 based on the operator's operation. In response to receiving the learning process request, the ASM simulator 38 generates learning data through computation with the activated sludge model. The computation requesting unit 36 transmits the learning data generated by the ASM simulator 38 to the arithmetic circuitry 4 via the communication network 9.

For example, the ASM simulator 38 can acquire a predicted value Fa of the state of treated water from time-series characteristic values Dats and time-series control target values RVts through computation with the activated sludge model. In this case, the computation requesting unit 36 transmits, to the arithmetic circuitry 4, learning data including the time-series characteristic values Dats, the time-series control target values RVts, and the predicted value Fa of the state of treated water.

Note that the time-series characteristic values Dats indicate temporal characteristic changes in the characteristic value Da of the state of the water treatment facility 1, which is detected by the one or more sensors 20. The predicted value Fa of the state of treated water is a predicted value of the state of treated water after the period Ta, and includes, for example, predicted values of the outflow amount, BOD, and concentration of total nitrogen of treated water.

The ASM simulator 38 can acquire the control target values RV1 and RV2 from the predicted value Fa of the state of treated water through computation with the activated sludge model. In this case, the computation requesting unit 36 transmits, to the arithmetic circuitry 4, learning data including the predicted value Fa of the state of treated water and the control target values RV1 and RV2.

The ASM simulator 38 can acquire information on the control target values RV1 and RV2 from the time-series characteristic values Dats and the time-series control target values RVts through computation with the activated sludge model. In this case, the computation requesting unit 36 transmits, to the arithmetic circuitry 4, learning data including the time-series characteristic values Dats, the time-series control target values RVts, and the information on the control target values RV1 and RV2.

The ASM simulator 38 can generate the above-described learning data, for example, when the data distribution of the time-series detection data selected by the reception processor 37 is biased or when the amount of learning data selected by the reception processor 37 is small.

For example, the ASM simulator 38 can generate learning data including: the time-series characteristic values Dats with time-dependent changes different from the time-dependent changes in the water treatment environment indicated by the time-series detection data Dts2 selected by the reception processor 37; and the time-series control target values RVts for the times corresponding to the time-series characteristic values Dats.

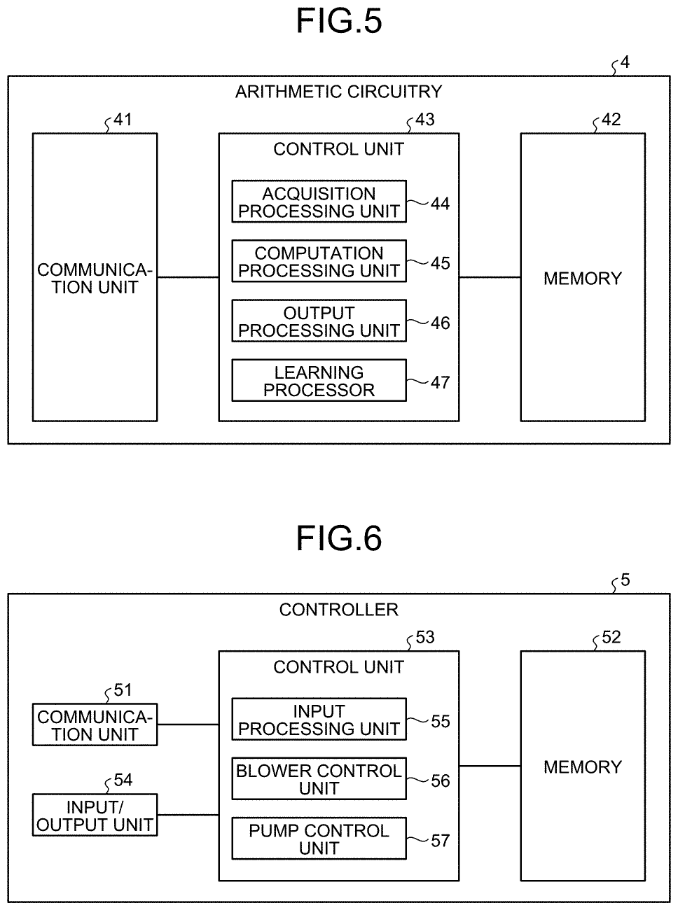

Next, the arithmetic circuitry 4 will be described. FIG. 5 is a diagram illustrating an exemplary configuration of the arithmetic circuitry according to the first embodiment. As illustrated in FIG. 5, the arithmetic circuitry 4 includes a communication unit 41, a memory 42, and a control unit 43.

The communication unit 41 is connected to the communication network 9. The control unit 43 can exchange data with the processor 3, the controller 5, and the storage 6 via the communication unit 41 and the communication network 9.

The memory 42 stores one or more calculation models. The calculation model stored in the memory 42 is, for example, a convolutional neural network or a recurrent neural network that: receives input of the time-series detection data Dts1 output from the sensor 2; and outputs the control target values RV for a plurality of control target devices. Note that the calculation model may be a calculation model other than the convolutional neural network or the recurrent neural network. The calculation model may be a calculation model generated by a learning algorithm such as linear regression or logistic regression, for example.

For example, the memory 42 stores calculation models including: a first calculation model that receives input of the time-series detection data Dts1 output from the sensor 2 and the time-series control target values RVts1 and outputs the predicted value Fa indicating the predicted state of treated water after the period Ta; and a second calculation model that receives input of the predicted value Fa of the state of treated water obtained through the computation with the first calculation model and outputs the control target values RV1 and RV2.

Instead of the first calculation model and the second calculation model, the memory 42 may store a third calculation model that receives input of the time-series detection data Dts1 and the time-series control target values RVts1 and outputs the control target values RV1 and RV2.

Note that the calculation model stored in the memory 42 may be any calculation model, other than the above-described examples, as far as the calculation model is capable of performing computation related to the control of the water treatment facility 1 by receiving input of the time-series detection data Dts1 output from the sensor 2.

For example, the calculation model may be a model that receives input of the time-series detection data Dts1 output from the sensor 2 but does not receive input of the time-series control target values RVts1. For example, the calculation model may be a model that receives input of only the time-series detection data Dts1 output from the sensor 2 and outputs a predicted value of each characteristic value Da. The calculation model may also be a model that receives input of only the time-series detection data Dts1 output from the sensor 2 and outputs the control target values RV1 and RV2.

The control unit 43 includes an acquisition processor 44, a computation processor 45, an output processor 46, and a learning processor 47. The acquisition processor 44 acquires the time-series detection data Dts1 from the processor 3 via the communication network 9 and the communication unit 41. The computation processor 45 reads out a calculation model from the memory 42, inputs the time-series detection data Dts1 to the read out calculation model, and performs computation with the calculation model to acquire the output of the calculation model.

For example, the computation processor 45 can obtain information on the predicted value Fa of the state of treated water by performing computation that uses the time-series detection data Dts1 and the time-series control target values RVts1 as input data for the first calculation model. The computation processor 45 can obtain information on the control target values RV1 and RV2 by performing computation that uses the predicted value Fa of the state of treated water obtained through the computation with the first calculation model as input data for the second calculation model.

The computation processor 45 can obtain information on the control target values RV1 and RV2 using the time-series detection data Dts1 and the time-series control target values RVts1 as input data for the third calculation model.

The output processor 46 outputs the information, acquired through the computations using the calculation models in the computation processor 45, from the communication unit 41 to the processor 3 as the output information of the arithmetic circuitry 4. The output information of the arithmetic circuitry 4 is, for example, information on the control target values RV for a plurality of control target devices described above and information on the predicted value Fa of the state of treated water described above.

The learning processor 47 can generate and update a calculation model based on the learning data output from the processor 3. The learning processor 47 stores the generated or updated calculation model in the memory 42.

For example, the learning processor 47 can perform the learning processes for the first calculation model and the second calculation model based on the time-series detection data Dts2 of which selection is received by the reception processor 37 and the time-series control target values RVts2. The learning processor 47 can perform the learning process for the first calculation model, for example, using the multiple pieces of detection data D in the period Tb among the detection data D included in the time-series detection data Dts2, and using, as the predicted value Fa, the characteristic values Dam-2, Dam-1, and Dam indicating the state of treated water among the characteristic values Da1 to Dam specified by the detection data D obtained after the period Ta from the latest detection data D of the multiple pieces of detection data D in the period Tb.

The learning processor 47 can also perform the learning process for the second calculation model, for example, based on the characteristic value Da indicating the state of treated water among the characteristic values specified by the detection data D, and the control target value RV for the detection time of the characteristic value Da.

The learning processor 47 can also perform the learning process for the third calculation model, for example, using the multiple pieces of detection data D in the period Tb among the detection data D included in the time-series detection data Dts2, and the control target value RV obtained after the period Ta from the latest detection data D of the multiple pieces of detection data D in the period Tb.

The learning processor 47 can perform the learning process for the first calculation model based on the result of computation by the ASM simulator 38. The learning processor 47 can perform the learning process for the first calculation model, for example, based on learning data including the time-series characteristic values Dats, the time-series control target values RVts, and the predicted value Fa of the state of treated water. The learning processor 47 can also perform the learning process for the second calculation model, for example, based on learning data including the predicted value Fa of the state of treated water and the control target values RV1 and RV2.

The learning processor 47 can also perform the learning process for the third calculation model based on: the time-series characteristic values Dats and the time-series control target values RVts; and the control target values RV1 and RV2 output from the ASM simulator 38.

Note that the learning data used in the learning processor 47 may be any data, other than the above-described learning data, as far as the data being capable of performing the learning process for a calculation model that performs computation related to the control of the water treatment facility 1 by receiving input of the time-series detection data Dts1 output from the sensor 2.

The neural network in the arithmetic circuitry 4 is an artificial neural network. The artificial neural network is a calculation model in which perceptrons are hierarchically arranged, each taking a weighted sum of input signals and applying a non-linear function called an activation function to produce an output. The output out of a perceptron can be expressed by Formula (1) below, where X=(x1, x2, . . . , and xn) is inputs, W=(w1, w2, . . . , and wn) is weights, f(·) is an activation function, and * is the element-wise product of vectors.

out=f(X*W) (1)

In a convolutional neural network, a perceptron takes two-dimensional signals corresponding to an image as inputs, calculates a weighted sum of the inputs, and passes the weighted sum to the next layer. A sigmoid function or a rectified linear unit (ReLU) function is used as the activation function.

The above-mentioned perceptrons are hierarchically arranged in the artificial neural network, and input signals are processed in each layer, whereby the result of identification is calculated. In the last layer, for example, if the task type in the artificial neural network is a regression task, the output of the activation function is directly used as the output of the task, and if the task type is a classification task, the softmax function is applied to the last layer to produce the output of the task.

In the case of the convolutional neural network, an artificial network is constructed as a map of two-dimensional signals. Each of the two-dimensional signals, which can be considered as corresponding to a perceptron, calculates a weighted sum for the feature map of the previous layer, and applies the activation function to produce the result as an output.

In the convolutional neural network, the above-mentioned processing is called convolution computation, which can also include a pooling layer inserted in each layer for performing pooling processing. The pooling layer performs downsampling by performing average value computation or maximum value computation on the feature map.

Learning of such an artificial neural network is performed by error backpropagation using, for example, a known stochastic gradient descent method. Error backpropagation is a framework in which the output error of the artificial neural network is propagated in order from the last layer to the preceding layers so that weights are updated.

Next, the controller 5 illustrated in FIG. 2 will be described. The controller 5 can control the water treatment facility 1 by controlling the blower 14, the pump 15, and the like. For example, the controller 5 can control the concentration of dissolved oxygen in the activated sludge mixture by controlling the blower 14 to adjust the amount of air to be sent into the activated sludge mixture. The controller 5 also adjusts the flow rate of the activated sludge to be returned from the final settling tank 13 to the treatment tank 12 by controlling the pump 15.

FIG. 6 is a diagram illustrating an exemplary configuration of the controller according to the first embodiment. As illustrated in FIG. 6, the controller 5 includes a communication unit 51, a memory 52, a control unit 53, and an input/output unit 54. The communication unit 51 is connected to the communication network 9. The control unit 53 can exchange data with the processor 3 via the communication unit 51 and the communication network 9.

The control unit 53 includes an input processing unit 55, a blower control unit 56, and a pump control unit 57. The input processing unit 55 acquires the control information output from the processor 3 via the communication unit 51, and stores the acquired control information in the memory 52. The control information stored in the memory 52 includes a control target value for the blower 14 and a control target value for the pump 15.

The blower control unit 56 reads out the control target value RV1 for the blower 14 stored in the memory 52. The blower control unit 56 also acquires, from the storage 6 or the sensor 20₅, detection data indicating the amount of dissolved oxygen detected by the sensor 20₅. The blower control unit 56 generates a control signal by proportional integral (PI) control or proportional integral differential (PID) control based on the control target value RV1 for the blower 14 and the amount of dissolved oxygen acquired. The blower control unit 56 outputs the generated control signal from the input/output unit 54 to the blower 14. The blower 14 adjusts the amount of air to be sent to the treatment tank 12 based on the control signal output from the input/output unit 54 of the controller 5.

The pump control unit 57 reads out the control target value RV2 for the pump 15 stored in the memory 52. The pump control unit 57 also acquires, from a sensor (not illustrated) via the input/output unit 54, detection data indicating the flow rate of activated sludge from the final settling tank 13 to the treatment tank 12. The pump control unit 57 generates a control signal by PI control or PID control based on the control target value RV2 for the pump 15 and the flow rate of activated sludge acquired. The pump control unit 57 outputs the generated control signal from the input/output unit 54 to the pump 15. The pump 15 adjusts the flow rate of activated sludge from the final settling tank 13 to the treatment tank 12 based on the control signal output from the input/output unit 54 of the controller 5.

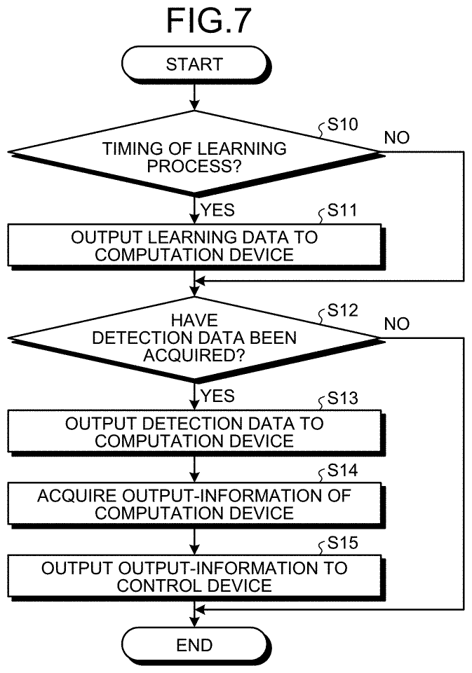

Next, the operation of the water treatment plant 100 will be described using flowcharts. FIG. 7 is a flowchart illustrating an exemplary procedure that is performed by the processor according to the first embodiment, which is repeatedly executed by the control unit 33 of the processor 3.

As illustrated in FIG. 7, the control unit 33 of the processor 3 determines whether the timing of a learning process has come or not (step S10). In step S10, the control unit 33 determines that the timing of a learning process has come, for example, in response to receiving the selection of detection data from the operator. Alternatively, in step S10, the control unit 33 determines that the timing of a learning process has come, for example, in response to receiving a request for a learning process using the ASM simulator 38 from the operator.

In response to determining that the timing of a learning process has come (step S10: Yes), the control unit 33 outputs learning data to the arithmetic circuitry 4 (step S11). In response to receiving the selection of detection data from the operator, the control unit 33 outputs, for example, learning data including the detection data selected by the operator to the arithmetic circuitry 4 in step S11.

After step S11 or in response to determining that the timing of a learning process has not come (step S10:

No), the control unit 33 determines whether detection data have been acquired (step S12). In response to determining that detection data have been acquired (step S12: Yes), the control unit 33 acquires the detection data from the storage 6 and outputs the acquired detection data to the arithmetic circuitry 4 (step S13).

Next, the control unit 33 acquires the output information output from the arithmetic circuitry 4 in response to step S13 (step S14), and outputs the acquired output information to the controller 5 (step S15). The output information includes control information as described above. After step S15 or in response to determining that detection data have not been acquired (step S12: No), the control unit 33 ends the procedure illustrated in FIG. 7.

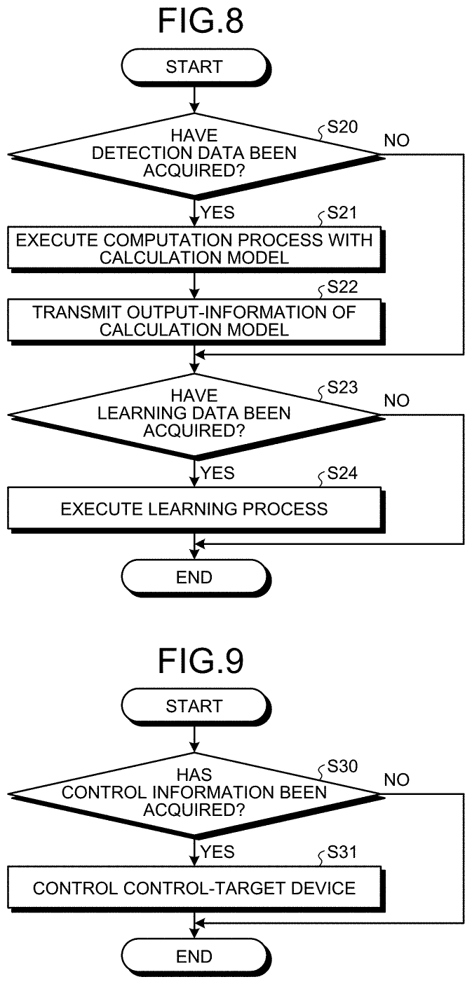

FIG. 8 is a flowchart illustrating an exemplary procedure that is performed by the arithmetic circuitry according to the first embodiment, which is repeatedly executed by the control unit 43 of the arithmetic circuitry 4.

As illustrated in FIG. 8, the control unit 43 of the arithmetic circuitry 4 determines whether detection data have been acquired from the processor 3 (step S20).

In step S20, in a case where the calculation model of the arithmetic circuitry 4 is a neural network other than a recurrent network, the control unit 43 determines whether the time-series detection data Dts1 have been acquired from the processor 3. In a case where the calculation model of the arithmetic circuitry 4 is a recurrent network, after acquiring the time-series detection data Dts1 from the processor 3, the control unit 43 determines that detection data have been acquired from the processor 3 each time the processor 3 sequentially acquires detection data output from the sensor 2.

In response to determining that detection data have been acquired (step S20: Yes), the control unit 43 executes a computation process using the calculation model by inputting the acquired detection data to the calculation model (step S21), and transmits the output information of the calculation model to the processor 3 (step S22).

After step S22 or in response to determining that detection data have not been acquired (step S20: No), the control unit 43 determines whether learning data have been acquired from the processor 3 (step S23). In response to determining that learning data have been acquired from the processor 3 (step S23: Yes), the control unit 43 executes the learning process for the calculation model using the learning data (step S24).

After step S24 or in response to determining that learning data have not been acquired (step S23: No), the control unit 43 ends the procedure illustrated in FIG. 8.

FIG. 9 is a flowchart illustrating an exemplary procedure that is performed by the controller according to the first embodiment, which is repeatedly executed by the control unit 53 of the controller 5.

As illustrated in FIG. 9, the control unit 53 of the controller 5 determines whether control information has been acquired from the processor 3 (step S30). In response to determining that control information has been acquired (step S30: Yes), the control unit 53 controls the control target device based on the acquired control information (step S31). After step S31 or in response to determining that control information has not been acquired (step S30: No), the control unit 53 ends the procedure illustrated in FIG. 9.

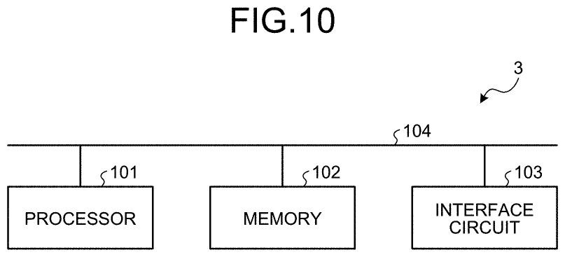

FIG. 10 is a diagram illustrating an exemplary hardware configuration of the processor according to the first embodiment. As illustrated in FIG. 10, the processor 3 includes a computer including a processor 101, a memory 102, and an interface circuit 103.

The processor 101, the memory 102, and the interface circuit 103 can exchange data with one another via a bus 104. The communication unit 31 is implemented by the interface circuit 103. The memory 32 is implemented by the memory 102. The processor 101 reads out and executes a program stored in the memory 102 to execute the functions of the data processor 34, the display processor 35, the computation requesting unit 36, the reception processor 37, and the ASM simulator 38. The processor 101 is an example of processing circuitry, and includes one or more of a central processing unit (CPU), a digital signal processer (DSP), and a system large scale integration (LSI).

The memory 102 includes one or more of a random access memory (RAM), a read only memory (ROM), a flash memory, and an erasable programmable read only memory (EPROM). The memory 102 includes a recording medium on which the above-mentioned computer-readable program is recorded. Such a recording medium includes one or more of a non-volatile or volatile semiconductor memory, a magnetic disk, a flexible memory, an optical disk, a compact disk, and a DVD.

In a case where the control unit 33 of the processor 3 is implemented by dedicated hardware, the control unit 33 is, for example, a single circuit, a composite circuit, a programmed processor, a parallel programmed processor, an application specific integrated circuit (ASIC), a field programmable gate array (FPGA), or a combination thereof.

The arithmetic circuitry 4 has a hardware configuration similar to the hardware configuration illustrated in FIG. 10. The communication unit 41 is implemented by the interface circuit 103. The memory 42 is implemented by the memory 102. The processor 101 reads out and executes a program stored in the memory 102 to execute the functions of the acquisition processor 44, the computation processor 45, the output processor 46, and the learning processor 47. In a case where the control unit 43 is implemented by dedicated hardware, the control unit 43 is, for example, a single circuit, a composite circuit, a programmed processor, a parallel programmed processor, an ASIC, an FPGA, or a combination thereof.

The controller 5 has a hardware configuration similar to the hardware configuration illustrated in FIG. 10. The communication unit 51 and the input/output unit 54 are implemented by the interface circuit 103. The memory 52 is implemented by the memory 102. The processor 101 reads out and executes a program stored in the memory 102 to execute the functions of the input processing unit 55, the blower control unit 56, and the pump control unit 57. In a case where the control unit 53 is implemented by dedicated hardware, the control unit 53 is, for example, a single circuit, a composite circuit, a programmed processor, a parallel programmed processor, an ASIC, an FPGA, or a combination thereof.

In the example described above, the information output from the arithmetic circuitry 4 is output through the processor 3 to the controller 5. Alternatively, the information output from the arithmetic circuitry 4 may be directly input to the controller 5 without going through the processor 3.

In the example described above, the arithmetic circuitry 4 computes the control target values RV1 and RV2 based on the output of a calculation model. Alternatively, the controller 5, instead of the arithmetic circuitry 4, may be configured to compute the control target values RV1 and RV2 5 based on the output of a calculation model. For example, the controller 5 may be configured to acquire information on the predicted value Fa of the state of treated water from the arithmetic circuitry 4 and compute the control target values RV1 and RV2 based on the predicted value Fa of the state of treated water.

In the water treatment plant 100, the arithmetic circuitry 4 may be provided in the controller 5, or the arithmetic circuitry 4 may be partially or entirely provided in the processor 3 or the controller 5. In the water treatment plant 100, the processor 3 may be partially provided in the controller 5. In the water treatment plant 100, the storage 6 may be provided in the processor 3 or the controller 5.

In the example described above, control target devices controlled by the controller 5 are the blower 14 and the pump 15, but control target devices controlled by the controller 5 may include devices other than the blower 14 and the pump 15. For example, control target devices may be a heater that adjusts the temperature of water in the treatment tank 12 and a device that controls the injection of chemical liquid into the treatment tank 12.

In the example described above, calculation models used in the computation processor 45 of the arithmetic circuitry 4 are the first calculation model, the second calculation model, and the third calculation model, which are non-limiting examples of calculation models used in the computation processor 45.

For example, calculation models used in the computation processor 45 may include a plurality of fourth calculation models that output predicted values of inflow water characteristics from time-series data of inflow water characteristics, and a fifth calculation model that outputs the control target value RV from predicted values of a plurality of inflow water characteristics obtained from the plurality of fourth calculation models. Note that the computation processor 45 can obtain information related to the control of the water treatment facility 1 using a calculation model specified by a request from the computation requesting unit 36. The information related to the control of the water treatment facility 1 is not limited to the control target value RV and may be a predicted value of the water treatment environment or the like.

As described above, the water treatment plant 100 according to the first embodiment includes: the water treatment facility 1 that performs water treatment; the sensor 2 that repeatedly detects the water treatment environment of the water treatment facility 1 to output the time-series detection data Dts1; and the processor 3. The processor 3 causes the arithmetic circuitry 4 to execute a computation related to the control of the water treatment facility 1 using the time-series detection data Dts1 output from the sensor 2 as input data for a calculation model generated by machine learning. Consequently, the water treatment plant 100 can perform more effective water treatment control against time-dependent changes in the water treatment environment. Note that the time-series detection data Dts1 are an example of time-series detection data.

A method of operating the water treatment plant 100 according to the first embodiment includes: repeatedly detecting the water treatment environment of the water treatment facility 1 using the sensor 2 to output the time-series detection data Dts1; and causing the arithmetic circuitry 4 to execute a computation related to the control of the water treatment facility 1 using the time-series detection data Dts1 output from the sensor 2 as input data for a calculation model generated by machine learning. Consequently, the water treatment plant 100 can perform more effective water treatment control against time-dependent changes in the water treatment facility 1.

The water treatment plant 100 includes the controller 5 that controls the water treatment facility 1 based on a result of the computation executed on the time-series detection data Dts1. Consequently, the water treatment plant 100 can automatically perform more effective water treatment control against time-dependent changes in the water treatment facility 1.

The processor 3 includes the display processor 35 that displays information related to a result of the computation executed on the time-series detection data Dts1. Therefore, the operator of the water treatment plant 100 can grasp information related to the control of the water treatment facility 1.

The processor 3 includes: the reception processor 37 that receives input of the control target value RV for the controller 5; and the data processor 34 that outputs, to the controller 5, the control target value RV received by the reception processor 37. Consequently, the operator of the water treatment plant 100 can cause the controller 5 to execute control that is based on information related to the control of the water treatment facility 1.

The controller 5 controls the water treatment facility 1 using proportional integral control or proportional integral differential control for control target devices. Consequently, in the water treatment plant 100, the water treatment facility 1 can be accurately controlled.

The arithmetic circuitry 4 includes, as the calculation model, a recurrent neural network that uses the time-series detection data Dts1 as input data. The processor 3 causes the arithmetic circuitry 4 to execute a computation with the recurrent neural network. In this way, the water treatment plant 100: prepares, as the calculation model, a recurrent neural network that uses the time-series detection data tsl as input data; and causes the arithmetic circuitry 4 to execute a computation with the recurrent neural network. Consequently, in the water treatment plant 100, computation related to the control of the water treatment facility 1 can be accurately controlled. After the computation with the recurrent neural network is started, because past data are set in the recurrent neural network, the processing interval in the arithmetic circuitry 4 can be improved.

The water treatment plant 100 includes the storage 6 that stores the time-series detection data output from the sensor 2. The processor 3 includes the reception processor 37 that receives a range to be used as learning data for the calculation model among the time-series detection data stored in the memory 32. The arithmetic circuitry 4 includes the learning processor 47 that executes a learning process for generation or update of the calculation model based on multiple pieces of detection data included in the range received by the reception processor 37 among the time-series detection data stored in the storage 6. Consequently, the operator: can select learning data; and, for example, by selecting time-series data suitable for learning of the calculation model, can generate or update the calculation model that enables accurate computation related to the control of the water treatment facility 1. The control unit 33 of the processor 3 can receive the setting of the period Ta from the operator in addition to the range to be used as learning data for the calculation model among the time-series detection data. Consequently, for example, improvement in reflection efficiency can be expected for both an event having a long-term change cycle and an event having a short-term change cycle. Note that multiple pieces of detection data included in the range received by the reception processor 37 are an example of multiple pieces of in-range detection data.

The processor 3 includes the ASM simulator 38 that simulates physical, biological, and scientific behavior in the water treatment. The ASM simulator 38 is an example of a simulator. The arithmetic circuitry 4 includes the learning processor 47 that generates or updates the calculation model based on a result of computation by the ASM simulator 38. Consequently, for example, when the data distribution of the time-series detection data obtained during the operation of the water treatment plant 100 is biased, the calculation model that enables accurate computation related to the control of the water treatment facility 1 can be generated or updated.

The above first embodiment describes an example in which the ASM simulator 38 is used. However, the present invention is not limited to this example. Other simulators that simulate physical, biological, and scientific behavior in water treatment may be used.

The above first embodiment describes an example in which the recurrent neural network or the convolutional neural network is used. However, the present invention is not limited to this example. Calculation models other than the recurrent neural network and the convolutional neural network may be used.

The configuration described in the above-mentioned embodiment indicates an example of the contents of the present invention. The configuration can be combined with another well-known technique, and a part of the configuration can be omitted or changed in a range not departing from the gist of the present invention.

### REFERENCE SIGNS LIST

1 water treatment facility; 2, 20, 20₁ to 20ₘ sensor; 3 processor; 4 arithmetic circuitry; 5 controller; 6 storage; 7 display; 8 input device; 9 communication network; 11 primary settling tank; 12 treatment tank; 13 final settling tank; 14 blower; 15 pump; 31, 41, 51 communication unit; 32, 42, 52 memory; 33, 43, 53 control unit; 34 data processor; 35 display processor; 36 computation requesting unit; 37 reception processor; 38 ASM simulator; 44 acquisition processor; 45 computation processor ; 46 output processor; 47 learning processor ; 54 input/output unit; 55 input processing unit; 56 blower control unit; 57 pump control unit; 100 water treatment plant.

1. A water treatment plant that performs water treatment using a water treatment facility, the water treatment plant comprising:
a sensor to repeatedly detect a water treatment environment of the water treatment facility to output time-series detection data; and
a processor to cause an arithmetic circuitry, which executes a computation related to control of the water treatment facility using a calculation model generated by machine learning, to execute the computation using the time-series detection data output from the sensor as input data.

2. The water treatment plant according to claim 1, comprising
a controller to perform the control based on a result of the computation executed on the time-series detection data.

3. The water treatment plant according to claim 1, comprising
a display processor to display information related to a result of the computation executed on the time-series detection data.

4. The water treatment plant according to claim 3, comprising
a controller to control the water treatment facility, wherein
the processor includes:
a reception processor to receive input of a control target value for the controller; and
a data processor to output, to the controller, the control target value received by the reception processor.

5. The water treatment plant according to claim 2, wherein
the controller performs the control using proportional integral control or proportional integral differential control.

6. The water treatment plant according to claim 1, comprising:
a storage to store the time-series detection data output from the sensor;
a reception processor to receive a range to be used as learning data for the calculation model among the time-series detection data stored in the storage; and
a learning processor to execute a learning process for generation or update of the calculation model based on multiple pieces of in-range detection data included in the range received by the reception processor among the time-series detection data stored in the storage.

7. The water treatment plant according to claim 6, comprising
a simulator to simulate physical, biological, and scientific behavior in the water treatment, wherein
the learning processor performs the generation or the update of the calculation model based on a result of computation by the simulator.

8. The water treatment plant according to claim 1, wherein
the arithmetic circuitry includes,
as the calculation model, a recurrent neural network that uses the time-series detection data as input data, and
the processor causes the arithmetic circuitry to execute a computation using the recurrent neural network.

9. The water treatment plant according to claim 1, wherein
the arithmetic circuitry is AI.

10. A method of operating a water treatment plant that performs water treatment using a water treatment facility, the method comprising:
repeatedly detecting a water treatment environment of the water treatment facility using a sensor to output time-series detection data; and
causing an arithmetic circuitry to execute a computation related to control of the water treatment facility using the time-series detection data output from the sensor as input data for a calculation model generated by machine learning.

11. The method of operating a water treatment plant according to claim 10, comprising:
preparing, as the calculation model, a recurrent neural network that uses the time-series detection data as input data; and
using the recurrent neural network for the computation.

12. The method of operating a water treatment plant according to claim 10, comprising
preparing AI as the arithmetic circuitry.
